(19) United States
(12) Patent Application Publication
(10) Pub. No.: US 2021/0284824 A1
(43) Pub. Date: Sep. 16, 2021

(54) TIRE SIDEWALL RUBBER MEMBER AND PNEUMATIC TIRE

(71) Applicant: Toyo Tire Corporation, Itami-shi, Hyogo (JP)

(72) Inventor: Akie Kurihara, Itami-shi (JP)

(73) Assignee: Toyo Tire Corporation, Itami-shi, Hyogo (JP)

(21) Appl. No.: 16/330,495

(22) PCT Filed: Sep. 27, 2017
(86) PCT No.: PCT/JP2017/034969

§ 371 Date: Mar. 5, 2019

(30) Foreign Application Priority Data
Oct. 14, 2016 (JP) 2016-202884

(51) Int. Cl. C08L 7/00; B60C 1/00; C08L 9/00

(52) U.S. Cl. CPC C08L 7/00; C08L 9/00; B60C 1/0025

(57) ABSTRACT

A tire sidewall rubber member according to an embodiment is made of a rubber composition containing: a diene rubber; a reinforcing filler containing 75 mass % or more of carbon black; a processing aid; a compound represented by formula (I) (wherein R¹ and R² represent a hydrogen atom, an alkyl group, an alkenyl group or an alkynyl group, and M⁺ is Na⁺, K⁺ or Li⁺). The processing aid to be used is at least one selected from the group consisting of a fatty acid metal salt, a fatty acid amide and a fatty acid ester, and having a difference (Tm3−Tm1) between a start point (Tm1) and an end point (Tm3) of an endothermic peak measured by a differential scanning calorimeter of 50° C. or more. Thus, tear resistance is improved while maintaining low heat generation properties and hardness.

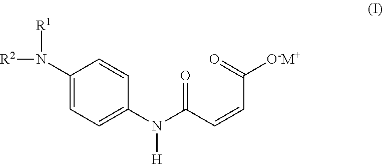

### TECHNICAL FIELD

The present invention relates to a sidewall rubber member constituting a sidewall part of a pneumatic tire and a pneumatic tire using the same.

### BACKGROUND ART

Tear resistance is one of properties required in a rubber composition forming a sidewall part of a pneumatic tire. A method of increasing a specific surface area of carbon black added as a reinforcing filler, a method of decreasing the amount of carbon black added, and the like are generally known as a method of improving tear resistance. However, when a specific surface area of carbon black is increased, low heat generation properties are deteriorated, that is, it is easy to generate heat, and low fuel consumption as a tire is impaired. On the other hand, when the amount of carbon black added is decreased, low heat generation properties can be improved while improving tear resistance, but hardness is deteriorated.

To improve low heat generation properties in a rubber composition for a sidewall, it is known to add (2Z)-4-[(4-aminophenyl)amino]-4-oxo-2-butenoic acid salt that is a compound for bonding carbon black to a diene rubber (see Patent Literatures 1 and 2). Dispersibility of carbon black is improved by the addition of the compound, thereby low heat generation properties can be improved. However, according to the present inventor's investigations, it was clarified that tear resistance is deteriorated.

Addition of a processing aid such as fatty acid amide to a rubber composition is conventionally known (see Patent Literature 3). However, the processing aid is generally added to a silica-added rubber composition in which the silica was used as a main reinforcing filler. In other words, the silica-added rubber composition increases a viscosity when adding the silica, leading to the deterioration of workability. Therefore, to decrease the viscosity and improve workability, a fatty acid type processing aid such as fatty acid amide is added. On the other hand, workability as in silica does not become a problem in a carbon black-added rubber composition in which carbon black was used as a main reinforcing filler. Therefore, a processing aid is not generally added in the carbon black-added rubber composition.

### CITATION LIST

### Patent Literature

Patent Literature 1: JP-A-2014-095019

Patent Literature 2: JP-A-2014-095015

Patent Literature 3: JP-A-2005-206673

### SUMMARY OF THE INVENTION

### Problems that the Invention is to Solve

In view of the above, an embodiment of the present invention has an object to provide a tire sidewall rubber member that can improve tear resistance while maintaining low heat generation properties and hardness.

### Means for Solving the Problems

The tire sidewall rubber member according to this embodiment comprises a rubber composition comprising a diene rubber, a reinforcing filler containing 75 mass % or more of carbon black, a processing aid comprising at least one selected from the group consisting of a fatty acid metal salt, a fatty acid amide and a fatty acid ester, and having a difference (Tm3−Tm1) between a start point (Tm1) and an end point (Tm3) of an endothermic peak measured by a differential scanning calorimeter of 50° C. or more and a compound represented by the following formula (I), wherein the content of the processing aid is 0.5 to 10 parts by mass per 100 parts by mass of the diene rubber.

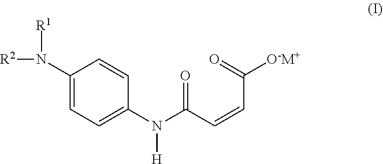

In the formula (I), R¹ and R² represent a hydrogen atom, an alkyl group having 1 to 20 carbon atoms, an alkenyl group having 1 to 20 carbon atoms or an alkynyl group having 1 to 20 carbon atoms, and R¹ and R² may be the same or different. M⁺ represents a sodium ion, a potassium ion or a lithium ion.

The pneumatic tire according to this embodiment is manufactured using the sidewall rubber member according to this embodiment.

### Effects of the Invention

According to this embodiment, tear resistance can be improved while maintaining low heat generation properties and hardness by using a fatty acid type processing aid having a specific melting point as above with the compound represented by the formula (I) in a carbon black-added rubber composition in which the carbon black was used a main reinforcing filler.

### BRIEF DESCRIPTION OF THE DRAWING

FIG. 1 is a view showing a start point (Tm1) and an end point (Tm3) of an endothermic peak in a differential calorie curve measured by a differential scanning calorimeter.

### MODE FOR CARRYING OUT THE INVENTION

The items relating to the embodiment of the present invention are described in detail below.

The tire sidewall rubber member according to this embodiment comprises a rubber composition comprising (A) a diene rubber, (B) a reinforcing filler containing carbon black, (C) a fatty acid type processing aid having a specific melting point and (D) a compound represented by the formula (I). The compound represented by the formula (I) can improve low heat generation properties by that an end amino group is reacted with a functional group on the surface of carbon black and a carbon-carbon double bond moiety is bonded to a diene rubber, thereby dispersibility of carbon black can be improved. On the other hand, tear resistance tends to be deteriorated by the addition of the compound. However, tear resistance can be improved while maintaining low heat generation properties and hardness by the addition of the fatty acid type processing aid having a specific melting point.

(A) Diene Rubber

Examples of the diene rubber as a rubber component include natural rubber (NR), isoprene rubber (IR), butadiene rubber (BR), styrene-butadiene rubber (SBR), styrene-isoprene rubber, butadiene-isoprene rubber, styrene-butadiene-isoprene rubber and nitrile rubber (NBR). Those rubbers can be used alone or as mixtures of two or more kinds. The diene rubber is more preferably at least one selected from the group consisting of natural rubber, isoprene rubber, styrene-butadiene rubber and butadiene rubber.

In one embodiment, 100 parts by mass of the diene rubber preferably contain 30 to 80 parts by mass of natural rubber and/or isoprene rubber and 70 to 20 parts by mass of butadiene rubber and more preferably contain 40 to 70 parts by mass of natural rubber and/or isoprene rubber and 60 to 30 parts by mass of butadiene rubber.

The butadiene rubber (that is, polybutadiene rubber) is not particularly limited, and examples thereof include (A1) high cis-butadiene rubber, (A2) syndiotactic crystal-containing butadiene rubber and (A3) modified butadiene rubber. Those can be used in any one kind or as mixtures of two or more kinds.

Example of the high cis-BR (A1) includes butadiene rubber having a cis content (that is, cis-1,4-bond content) of 90 mass % or more (preferably 95 mass % or more), and examples thereof include a cobalt type butadiene rubber polymerized using a cobalt catalyst, a nickel type butadiene rubber polymerized using a nickel catalyst and a rare earth type butadiene rubber polymerized using a rare earth element catalyst. The rare earth type butadiene rubber is preferably a neodymium type butadiene rubber polymerized using a neodymium catalyst, and the neodymium type butadiene rubber having a cis content of 96 mass % or more and a vinyl content (that is, 1,2-vinyl bond content) of less than 1.0 mass % (preferably 0.8 mass % or less) is preferably used. The use of the rare earth type butadiene rubber is advantageous to the improvement of low heat generation properties. The cis content and vinyl content are values calculated by an integration ratio of ¹H-NMR spectrum. Specific example of the cobalt type BR includes “UBEPOL BR” manufactured by Ube Industries, Ltd. Specific examples of the neodymium type BR include “BUNA CB22” and “BUNA CB25” manufactured by LAXESS.

Butadiene rubber that is a rubber resin composite comprising high cis-butadiene rubber as a matrix and syndiotactic 1,2-polybutadiene crystals (SPB) dispersed therein is used as the syndiotactic crystal-containing butadiene rubber (SPB-containing BR) (A2). The use of the SPB-containing BR is advantageous to the improvement of hardness. The SPB content in the SPB-containing BR is not particularly limited, and for example, may be 2.5 to 30 mass % and may be 10 to 20 mass %. The SPB content in the SPB-containing BR is obtained by measuring a boiling n-hexane insoluble content. Specific example of the SPB-containing BR includes “UBEPOL VCR” manufactured by Ube Industries, Ltd.

Examples of the modified BR (A3) include an amine-modified BR and a tin-modified BR. The use of the modified BR is advantageous to the improvement of low heat generation properties. The modified BR may be an end-modified BR having a functional group introduced in at least one end of a molecular chain of BR, may be a main chain-modified BR having a functional group introduced in the main chain, and may be a main chain and end-modified BR having functional groups introduced in the main chain and the end. Specific example of the modified BR includes “BR 1250H” (amine end-modified BR) manufactured by Zeon Corporation.

In one embodiment, when the high cis-BR (A1) and the SPB-containing BR (A2) are used together, 100 parts by mass of the diene rubber may contain 40 to 70 parts by mass of NR and/or IR, 20 to 40 parts by mass of the high cis-BR and 10 to 30 parts by mass of the SPB-containing BR. When the high cis-BR (A1) and the modified BR (A3) are used together, 100 parts by mass of the diene rubber may contain 40 to 70 pails by mass of NR and/or IR, 20 to 40 parts by mass of the high cis-BR and 10 to 30 parts by mass of the modified BR. When the cobalt type BR and the neodymium type BR are used together as the high cis-BR (A1), 100 parts by mass of the diene rubber may contain 40 to 70 parts by mass of NR and/or IR, 20 to 40 parts by mass of the cobalt type BR and 10 to 30 parts by mass of the neodymium type BR.

(B) Reinforcing Filler

As the reinforcing filler, carbon black is used as a main component. Specifically, the reinforcing filler contains carbon black in an amount of 75 mass % or more based on the total amount of the reinforcing filler. The reason for this is that tear resistance is improved while maintaining low heat generation properties and hardness in a carbon black-added rubber composition for a sidewall in which the carbon black is a main reinforcing filler. For this reason, the reinforcing filler may be carbon black alone and may contain 75 mass % or more of carbon black and a small amount (that is, 25 mass % or less) of silica. More preferably, the carbon black content is 80 mass % or more based on the total amount of the reinforcing filler.

The carbon black is not particularly limited, and for example, carbon black having a nitrogen adsorption specific surface area (N₂SA) (JIS K6217-2) of 30 to 120 m²/g is preferably used. Specific examples of the carbon black include ISAF grade (N200 Series), HAF grade (N300 Series), FEF grade (N500 Series) and GPF grade (N100 Series) (all is ASTM grade). N₂SA is more preferably 40 to 100 m²/g and still more preferably 50 to 90 m²/g.

The amount of the reinforcing filler added is not particularly limited. However, from the standpoint of reinforcing properties required in a sidewall part, the amount of the reinforcing filler is preferably 20 to 100 parts by mass and more preferably 30 to 80 parts by mass, per 100 parts by mass of the diene rubber. The amount may be 40 to 60 parts by mass. The amount of the carbon black added is preferably 20 to 80 parts by mass and more preferably 30 to 60 parts by mass, per 100 parts by mass of the diene rubber. The amount may be 40 to 60 parts by mass. The amount of the silica added is preferably 20 parts by mass or less and more preferably 10 parts by mass or less, per 100 parts by mass of the diene rubber.

(C) Fatty Acid Type Processing Aid

Fatty acid type processing aid having specific melting point is used as the processing aid. Specifically, a processing aid comprising at least one selected from the group consisting of a fatty acid metal salt, a fatty acid amide and a fatty acid ester and having a difference between a start point (Tm1) and an end point (Tm3) of an endothermic peak measured by a differential scanning calorimeter of 50° C. or more (that is, Tm3−Tm1≥50° C.) is used. When the fatty acid type processing aid having large difference (Tm3−Tm1) between the start point and the end point of an endothermic peak, that is, having broad distribution, is used, the processing aid is easy to be compatible with the diene rubber that is a polymer having distribution in molecular weight, that is, has good compatibility with the diene rubber. Furthermore, the interaction between the carbon black and the diene rubber is increased by the addition of the compound of the formula (I). As a result, it is considered that tear force is greatly improved.

The difference (Tm3−Tm1) of an endothermic peak of the processing aid is preferably 55° C. or more and more preferably 60° C. or more. The upper limit of the difference (Tm3−Tm1) is not particularly limited. For example, the difference may be 100° C. or less, may be 80° C. or less and may be 70° C. or less. Peak top temperature (Tm2) of an endothermic peak of the processing aid is not particularly limited, but is preferably 60 to 130° C. and more preferably 80 to 120° C.

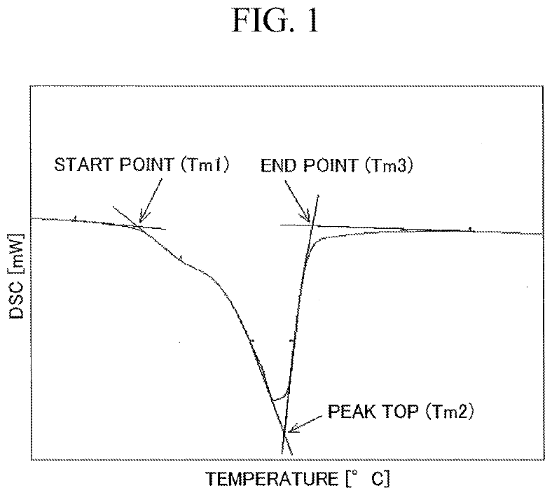

The start point (Tm1) of an endothermic peak used herein is an endotherm start point (temperature at which fusion starts) of an endothermic peak derived from fusion in a differential calorie curve measured by DSC and is called an onset temperature. In detail, the start point (Tm1) is a temperature at an intersection point of a tangent line of a curve in a depressed portion toward the endotherm side from the endotherm start and a straight line extending a base line at a low temperature side (substantially flat part free of the influence of fusion before endotherm start), in a differential calorie curve as shown in FIG. 1.

The end point (Tm3) of an endothermic peak is an endotherm end point (temperature at which fusion ends) of the endothermic peak and is called an endset temperature. In detail, the end point (Tm3) is a temperature at an intersection point of a tangent line of a curve in a depressed portion toward the endotherm side from the endotherm end and a straight line extending a base line of a high temperature side (substantially flat part after endotherm end), in a differential calorie curve as shown in FIG. 1.

The peak top temperature (Tm2) is the maximum endothermic temperature of the endothermic peak and is a temperature at an intersection point of tangents of curves at both sides reaching the maximum endothermic point as shown in FIG. 1.

A method for preparing the processing aid having the difference (Tm3−Tm1) of an endothermic peak of 50° C. or more is not particularly limited, and examples thereof include a method of broadening a carbon number distribution of the constituent fatty acid and a method of combining at least two selected from a fatty acid metal salt, a fatty acid amide and a fatty acid ester.

The fatty acid of the fatty acid metal salt used as the processing aid is not particularly limited, and examples thereof include saturated fatty acid and/or unsaturated fatty acid, having 5 to 36 carbon atoms. The fatty acid is more preferably saturated fatty acid and/or unsaturated fatty acid, having 8 to 24 carbon atoms. Specific examples of the fatty acid include octanoic acid, capric acid, lauric acid, myristic acid, palmitic acid, stearic acid, arachidic acid, oleic acid, linoleic acid and linolenic acid. Examples of the metal salt include an alkali metal salt such as sodium salt and potassium salt, an alkaline earth metal salts such as magnesium salt and calcium salt, and a transition metal salt such as zinc salt, cobalt salt and copper salt. Of those, an alkali metal salt and/or an alkaline earth metal salt are preferred, and potassium salt and/or calcium salt are more preferred.

The fatty acid of the fatty acid amide is not particularly limited, and similar to the fatty acid metal salt, examples thereof include saturated fatty acid and/or unsaturated fatty acid, having 5 to 36 carbon atoms. The fatty acid is more preferably saturated fatty acid and/or unsaturated fatty acid, having 8 to 24 carbon atoms. The fatty acid amide may be a primary amide such as stearic acid amide, and may be a secondary amide or a tertiary amide, obtained by reacting a fatty acid compound with a primary amine or a secondary amine such as monoethanol amine and diethanol amine. Furthermore, the fatty acid amide may be an alkylene bis-fatty acid amide having two fatty acid residues. In the case of the alkylene bis-fatty acid amide, the carbon number of the fatty acid is a carbon number per one amide group. The alkylene is preferably methylene or ethylene. The fatty acid amide is preferably a fatty acid alkanol amide (that is, a fatty acid alkanol amine salt) and more preferably fatty acid ethanol amide.

The fatty acid of the fatty acid ester is not particularly limited, and similar to the fatty acid metal salt, examples thereof include saturated fatty acid and/or unsaturated fatty acid, having 5 to 36 carbon atoms. The fatty acid is more preferably saturated fatty acid and/or unsaturated fatty acid, having 8 to 24 carbon atoms. The alcohol of the fatty acid ester is not particularly limited, and examples thereof include a monohydric alcohol such as methanol, ethanol, propanol and butanol, and further include a di- or more hydric alcohol such as glycol, glycerin, erythritol and sorbitol.

A mixture of (C1) a fatty acid metal salt and (C2) a fatty acid amide and/or a fatty acid ester (a fatty acid amide and a fatty acid ester are hereinafter collectively referred to as a fatty acid derivative) is preferably used as the processing aid. The fatty acid amide is more preferably used as the fatty acid derivative (C2). The ratio between the fatty acid metal salt (C1) and the fatty acid derivative (C2) is not particularly limited, but is preferably C1/C2=2/8 to 8/2 in mass ratio.

The amount of the processing aid added is preferably 0.5 to 10 parts by mass and more preferably 1 to 8 parts by mass, per 100 parts by mass of the diene rubber. The amount may be 2 to 5 parts by mass. When the amount of the processing aid added is 0.5 parts by mass or more, tear resistance can be improved and when the amount is 10 parts by mass or less, tear resistance can be improved without influence to other properties.

(D) Compound Represented by Formula (I)

The compound represented by the following formula (I) is added to the rubber composition according to this embodiment.

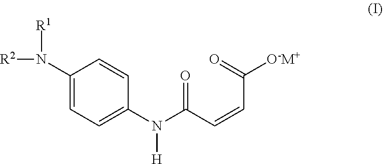

In the formula (I), R¹ and R² represent a hydrogen atom, an alkyl group having 1 to 20 carbon atoms, an alkenyl group having 1 to 20 carbon atoms or an alkynyl group having 1 to 20 carbon atoms, and R¹ and R² may be the same or different.

Examples of the alkyl group of R¹ and R² include methyl group, ethyl group, n-propyl group, isopropyl group, n-butyl group, sec-butyl group and tert-butyl group. Examples of the alkenyl group of R¹ and R² include vinyl group, allyl group, 1-propenyl group and 1-methylethenyl group. Examples of the alkynyl group of R¹ and R² include ethynyl group and propargyl group. Those alkyl group, alkenyl group and alkynyl group each have the number of carbon atoms of preferably 1 to 10 and more preferably 1 to 5. R¹ and R² are preferably a hydrogen atom or an alkyl group having 1 to 5 carbon atoms, more preferably a hydrogen atom or methyl group and still more preferably a hydrogen atom. In one embodiment, —NR¹R² in the formula (I) is preferably —NH₂, —NHCH₃ or —N(CH₃)₂ and more preferably —NH₂.

M⁺ in the formula (I) is a sodium ion, a potassium ion or a lithium ion and is preferably a sodium ion.

The amount of the compound represented by the formula (I) added is not particularly limited, but is preferably 0.1 to 10 parts by mass and more preferably 0.5 to 8 parts by mass, per 100 parts by mass of the diene rubber. The amount may be 1 to 5 parts by mass. When the amount of the compound represented by the formula (I) added is 0.1 parts by mass or more, the improvement effect of low heat generation properties can be enhanced and when the amount added is 10 parts by mass or less, deterioration of tear resistance can be suppressed.

In addition to the above-described each component, various additives generally used in a rubber composition for a tire sidewall rubber member, such as zinc oxide, wax, stearic acid, an age resister, a vulcanizing agent and a vulcanization accelerator can be added to the rubber composition according to this embodiment. Examples of the vulcanizing agent include powdered sulfur, precipitated sulfur, colloidal sulfur, insoluble sulfur and highly dispersible sulfur. Although not particularly limited, the amount of the vulcanizing agent added is preferably 0.1 to 10 parts by mass and more preferably 0.5 to 5 parts by mass, per 100 parts by mass of the diene rubber. The amount of the vulcanization accelerator added is preferably 0.1 to 7 parts by mass and more preferably 0.5 to 5 parts by mass, per 100 parts by mass of the diene rubber.

The rubber composition can be prepared by kneading the necessary components according to the conventional method using a mixing machine generally used, such as Banbury mixer, a kneader or rolls. For example, other additives excluding a vulcanizing agent and a vulcanization accelerator are added to a diene rubber together with a reinforcing filler, a processing aid and the compound of the formula (I), followed by mixing, in a first mixing step. A vulcanizing agent and a vulcanization accelerator are then added to the mixture thus obtained, followed by mixing, in a final mixing step. Thus, a rubber composition can be prepared.

The sidewall rubber member according to this embodiment is produced using the rubber composition. The rubber composition is extrusion-molded into a predetermined cross-sectional shape corresponding to a sidewall part. Alternatively, a ribbon-shaped rubber strip comprising the rubber composition is spirally wound on a drum to form into a cross-sectional shape corresponding to a sidewall part. Thus, an unvulcanized sidewall rubber member is obtained. The sidewall rubber member is fabricated into a tire shape together with other tire members constituting a tire, such as an inner liner, a carcass, a belt, a bead core, a bead filler and a tread rubber, according to the conventional method. Thus, a green tire (unvulcanized tire) is obtained. The green tire thus obtained is vulcanization-molded at, for example, 140 to 180° C. according to the conventional method. Thus, a pneumatic tire having a sidewall part formed from the sidewall rubber member is obtained.

The kind of the pneumatic tire according to this embodiment is not particularly limited, and examples of the pneumatic tire include various tires such as tires for passenger cars and heavy load tires used in tucks, buses and the like.

### EXAMPLES

Examples of the present invention are described below, but the present invention is not construed as being limited to those examples.

Banbury mixer was used. Compounding additives excluding a vulcanization accelerator and sulfur were added to a diene rubber according to the formulations (parts by mass) shown in Table 1 below, followed by mixing, in a first mixing step (discharge temperature: 160° C.). A vulcanization accelerator and sulfur were added to the mixture obtained, followed by kneading, in a final mixing step (discharge temperature: 90° C.). Thus, a rubber composition used as a sidewall rubber member was prepared. The details of each component in Table 1 are as follows.

Natural rubber: RSS#3

BR 1: Cobalt type BR, “UBEPOL BR150” (cis content=98 mass %) manufactured by Ube Industries, Ltd.

BR 2: SPB-containing BR. “UBEPOL VCR617” (cis content of high cis-BR as matrix=98 mass %, SPB content in SPB-containing BR=17 mass %) manufactured by Ube Industries, Ltd.

Carbon black: HAF, “SEAST 3” (N₂SA=79 m²/g) manufactured by Tokai Carbon Co., Ltd.

Zinc oxide: “Zinc Oxide #1” manufactured by Mitsui Mining & Smelting Co., Ltd.

Wax: “OZOACE 0355” manufactured by Nippon Seiro Co., Ltd.

Stearic acid “Industrial Stearic Acid” manufactured by Kao Corporation

Sulfur: “5% Oil-Treated Powdered Sulfur” manufactured by Tsurumi Chemical Industry Co., Ltd.

Vulcanization accelerator: “NOCCELER NS-P” manufactured by Ouchi Shinko Chemical Industrial Co., Ltd.

Processing aid 1: “AFLUX 16” (mixture of 50% fatty acid calcium salt and 50% fatty acid ethanol amide, Tm1=53° C., Tm2=113° C., Tm3=120° C., Tm3-Tm1=67° C.) manufactured by Rhein Chemie

Processing aid 2: “ULTRA FLOW 160” (mixture of fatty acid calcium salt and fatty acid amide, Tm1=61° C., Tm2=99° C., Tm3=113° C., Tm3-Tm1=52° C.) manufactured by PERFORMANCE ADDITIVE

Processing aid 3: “ULTRA FLOW 500” (fatty acid zinc salt, Tm1=81° C., Tm2=108° C., Tm3=114° C., Tm3-Tm1=33° C.) manufactured by PERFORMANCE ADDITIVE

Processing aid 4: “DIAMID BH” (fatty acid amide, Tm1=111° C., Tm2=113° C., Tm3=118° C., Tm3-Tm1=7° C.) manufactured by Nihon Kasei Chemical Co., Ltd.

Compound (I): (2Z)-4-[(4-aminophenyl)amino]-4-oxo-2-butenoic acid sodium salt (compound represented by the following formula (I′)) manufactured by Sumitomo Chemical Co., Ltd.

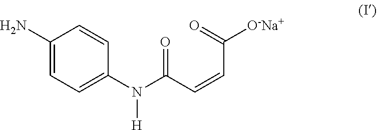

Tm1. Tm2 and Tm3 of the processing aid were measured using “DSC 8220” manufactured by METTLER TOLEDO. Temperature was increased from 25° C. to 250° C. in a temperature rising rate of 10K/min in air to obtain a differential calorie curve, and the following Tm1, Tm2 and Tm3 were calculated from the curve.

Tm1: Temperature at an intersection point of a straight line extending a base line of a low temperature side to a high temperature side and a tangent line drawn to the curve of a low temperature side of fusion peak (endothermic peak) at a point that a gradient is the maximum

Tm2: Temperature at an intersection point of a tangent line drawn to the curve of a low temperature side of fusion peak at a point that a gradient is the maximum and a tangent line drawn to the curve of a high temperature side of fusion peak at a point that a gradient is the maximum

Tm3: Temperature at an intersection point of a straight line extending a base line of a high temperature side to a low temperature side and a tangent line drawn to the curve of a high temperature side of fusion peak at a point that a gradient is the maximum

However, when a step-like change part (that is, a part first depressed to an endotherm side from a base line of a low temperature side in the example of FIG. 1) is present in the fusion peak curve as in FIG. 1, Tm1 and Tm3 were calculated such that the temperature is an intersection point of a tangent line drawn at a point that a gradient of the curve in the step-like change part is the maximum and a base line.

Each rubber composition was vulcanized at 150° C. for 30 minutes to obtain a test piece having a predetermined shape, and hardness, tear resistance and low heat generation properties of each test piece obtained were measured and evaluated. The measurement and evaluation methods are as follows.

Hardness was measured at 23° C. using Type A durometer according to JIS K6253, and was indicated by an index as the value of Comparative Example 1 being 100. Hardness is high as the index is large.

Tear resistance: Using a sample obtained by punching into a crescent shape specified in JIS K6252 and making a cut of 0.50±0.08 mm in the center of depression, a test was conducted in a tensile rate of 500 mm/min by a tensile tester manufactured by Shimadzu Corporation, and tear strength was measured. The value was indicated by an index as the value of Comparative Example 1 being 100. Tear strength is large and tear resistance is excellent as the index is large. When the difference in indexes is 5 or more, it is considered that the improvement effect of tear resistance is achieved.

Low heat generation properties: Loss factor tan δ was measured under the conditions of frequency: 10 Hz, static strain: 10%, dynamic strain: +1% and temperature: 60° C., using a viscoelasticity testing machine manufactured by Toyo Seiki Seisaku-Sho. The inverse number of tan δ was indicated by an index as the value of Comparative Example 1 being 100. Tan δ is small and low heat generation properties are excellent as the index is large. This means that rolling resistance as a tire is small and low fuel consumption is excellent. When the index is 101 or more, it is considered that the improvement effect of low heat generation properties is achieved.

TABLE 1

| Formulations | Com. | Com. | Com. | Com. | Com. | Com. | Com. | | | | | |
|---|---|---|---|---|---|---|---|---|---|---|---|---|
| (parts by mass) | Ex. 1 | Ex. 2 | Ex. 3 | Ex. 4 | Ex. 5 | Ex. 6 | Ex. 7 | Ex. 1 | Ex. 2 | Ex.3 | Ex. 4 | Ex. 5 |
| Natural Rubbcr | 50 | 50 | 50 | 50 | 50 | 50 | 50 | 50 | 50 | 50 | 50 | 50 |
| BR1 | 50 | 50 | 50 | 50 | 50 | 50 | 30 | 50 | 30 | 50 | 50 | 50 |
| BR2 | | | | | | | 20 | | 20 | | | |
| Carbon black | 50 | 40 | 50 | 50 | 50 | 50 | 50 | 50 | 50 | 50 | 50 | 50 |
| Zinc oxide | 3 | 3 | 3 | 3 | 3 | 3 | 3 | 3 | 3 | 3 | 3 | 3 |
| Wax | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 |
| Sulfur | 2 | 2 | 2 | 2 | 2 | 2 | 2 | 2 | 2 | 2 | 2 | 2 |
| Vulcanization accelerator | 1 | 1 | 1 | 1 | 1 | 1 | 1 | 1 | 1 | 1 | 1 | 1 |
| Processing aid 1 | | | | | | 3 | 3 | 3 | 3 | | 1 | 5 |
| Processing aid 2 | | | | | | | | | | 3 | | |
| Proecaaing aid 3 | | | | 3 | | | | | | | | |
| Processing aid 4 | | | | | 3 | | | | | | | |
| Compound (I) | | | 2 | 2 | 2 | | | 2 | 2 | 2 | 3 | 1 |
| Evaluation (index) | | | | | | | | | | | | |
| Hardness | 100 | 93 | 98 | 98 | 100 | 101 | 104 | 100 | 108 | 100 | 100 | 102 |
| Tear maistance | 100 | 113 | 92 | 89 | 92 | 102 | 101 | 116 | 109 | 113 | 104 | 118 |
| Low heat generation | 100 | 105 | 103 | 101 | 99 | 96 | 97 | 101 | 101 | 101 | 102 | 101 |
| properties | | | | | | | | | | | | |

The results are shown in Table 1. Comparing with Comparative Example 1 as a control, Comparative Example 2 was that low heat generation properties were improved while improving tear resistance, by decreasing the amount of carbon black but hardness was deteriorated. Comparative Example 3 was that low heat generation properties were improved by adding the compound (I) but tear resistance was greatly deteriorated. Comparative Examples 4 and 5 were that fatty acid type processing aid was added together with the compound (1) but because the processing aid had small difference (Tm3-Tm1) of an endothermic peak, the improvement effect of tear resistance was not obtained as compared with Comparative Example 3. On the other hand, Comparative Examples 6 and 7 were that the processing aid having large difference (Tm3-Tm1) of an endothermic peak was used, but because the compound (I) was not added, the improvement effect of low heat generation properties were not obtained and the improvement effect of tear resistance was not observed, as compared with Comparative Example 1.

On the other hand, in Examples 1 to 5 in which fatty acid type processing aid having large difference (Tm3−Tm1) of an endothermic peak was added together with the compound (1), tear resistance was greatly improved while maintaining hardness and while maintaining or improving low heat generation properties. Not only the deterioration of tear resistance by the compound (I) was compensated but tear resistance was improved, by adding a processing acid that is not generally added in a carbon black-added rubber composition in which the carbon black is a main reinforcing filler.

1. A tire sidewall rubber member comprising a rubber composition comprising:
a diene rubber,
a reinforcing filler containing 75 mass % or more of carbon black,
a processing aid comprising at least one selected from the group consisting of a fatty acid metal salt, a fatty acid amide and a fatty acid ester, and having a difference (Tm3-Tm1) between a start point (Tm1) and an end point (Tm3) of an endothermic peak measured by a differential scanning calorimeter of 50° C. or more, and
a compound represented by the following formula (I),
wherein the content of the processing aid is 0.5 to 10 parts by mass per 100 parts by mass of the diene rubber: 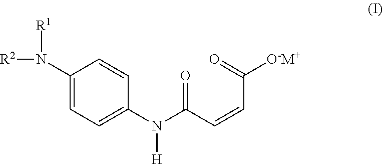
wherein R¹ and R² represent a hydrogen atom, an alkyl group having 1 to 20 carbon atoms, an alkenyl group having 1 to 20 carbon atoms or an alkynyl group having 1 to 20 carbon atoms, R¹ and R² may be the same or different, and M⁺ represents a sodium ion, a potassium ion or a lithium ion.

2. The tire sidewall rubber member according to claim 1, wherein the reinforcing filler is contained in an amount of 20 to 100 parts by mass per 100 parts by mass of the diene rubber, and the compound represented by the formula (I) is contained in an amount of 0.1 to 10 parts by mass per 100 parts by mass of the diene rubber.

3. The tire sidewall rubber member according to claim 1, wherein the processing aid is a mixture of a fatty acid metal salt, and a fatty acid amide and/or a fatty acid ester.

4. The tire sidewall rubber member according to claim 1, wherein 100 parts by mass of the diene rubber contain 30 to 80 parts by mass of natural rubber and/or isoprene rubber and 70 to 20 parts by mass of butadiene rubber.

5. The tire sidewall rubber member according to claim 1, wherein 100 parts by mass of the diene rubber contain 40 to 70 parts by mass of natural rubber and/or isoprene rubber, 20 to 40 parts by mass of high cis-butadiene rubber having a cis content of 90 mass % or more, and 10 to 30 parts by mass of syndiotactic crystal-containing butadiene rubber.

6. The tire sidewall rubber member according to claim 1, wherein the processing aid has a peak top temperature (Tm2) of an endothermic peak of 60 to 130° C.

7. A pneumatic tire manufactured by using the sidewall rubber member according to claim 1.
